(19) United States
(12) Patent Application Publication
(10) Pub. No.: US 2015/0174555 A1
(43) Pub. Date: Jun. 25, 2015

(54) EXHAUST GAS PURIFYING CATALYST AND METHOD FOR PRODUCING SAME

(71) Applicants: Iwao Nitta, Susono-shi (JP); Naotaka Sawada, Susono-shi (JP)

(72) Inventors: Iwao Nitta, Susono-shi (JP); Naotaka Sawada, Susono-shi (JP)

(73) Assignee: TOYOTA JIDOSHA KABUSHIKI KAISHA, Toyota-shi (JP)

(21) Appl. No.: 14/416,962

(22) PCT Filed: Aug. 10, 2012
(86) PCT No.: PCT/JP2012/070523

§ 371 Date: Jan. 23, 2015

(51) Int. Cl. B01J 23/75; B01J 37/02; B01J 35/00; B01J 37/04; B01J 35/02; B01J 23/10; B01J 37/08

(52) U.S. Cl. CPC B01J 23/75; B01J 23/10; B01J 37/024; B01J 37/08; B01J 37/04; B01J 35/026; B01J 35/0006

(57) ABSTRACT

An exhaust gas purifying catalyst obtained by loading a solid material composed of M (M is a metal element selected from Cu, Mn, Ni, Fe, Mg and Ag), Co and O on a support having an oxygen absorbing/releasing ability through a thin layer containing Al and O; and a method for producing the catalyst above, including steps of coating the surface of the support having an oxygen absorbing/releasing ability with a precursor for giving a thin layer containing Al and O, and depositing a precursor of a solid material composed of M, Co and O, which is produced from an acid salt of Co and an acid salt of a metal M (M is a metal element selected from Cu, Mn, Ni, Fe, Mg and Ag).

### TECHNICAL FIELD

The present invention relates to an exhaust gas purifying catalyst and a production method thereof. More specifically, the present invention relates, to an exhaust gas purifying catalyst using no platinum-based noble metal and capable of substantially maintaining the ability to purify an unreacted substance such as carbon monoxide (CO) even under a low ambient temperature after exposure to a high temperature, and a production method thereof.

### BACKGROUND ART

Exhaust gas discharged from an internal combustion engine such as an automobile engine contains CO and hydrocarbon (HC) that are unreacted substances, because the fuel, i.e., gasoline or kerosene, is not completely oxidized under a low ambient temperature, for example, at the start of operation.

A platinum-based noble metal such as Pt, Pd and Rh is used as an essential component in the catalyst for removing CO or HC contained in the exhaust gas, but from a resource standpoint, a metal or metal oxide catalyst except for low-abundance platinum-based noble metals is demanded.

A catalyst obtained by loading an oxide of a non-metal element such as Co₃O₄ on a support is known as a catalyst exhibiting a CO purification performance, but the catalyst is insufficient in the purifying activity, particularly, the activity under a low ambient temperature, and improvement thereof is demanded.

On the other hand, the exhaust gas purifying catalyst may be exposed to a high temperature depending on the conditions during operation, and therefore the exhaust gas purifying catalyst is required to substantially maintain the catalytic activity even after exposure to a high temperature.

For example, Kokai (Japanese Unexamined Patent Publication) No. 2-269669 describes a nitrogen oxide purifying catalyst obtained by forming a solid solution of copper oxide, cobalt oxide, iron oxide or nickel oxide with aluminum oxide, and it is disclosed that, as a specific example, a nitrogen oxide purifying catalyst obtained by forming a solid solution of copper oxide, cobalt oxide, iron oxide or nickel oxide at 1.6 mol %, 6.25 mol or 12.5 mol % with aluminum oxide exhibits a maximum NOₓ purifying activity of about 50% after being heat-treated up to 800° C. and thereby exposed to a high temperature.

Kokai No. 9-225264 describes an exhaust gas purifying catalyst having provided therein a first layer containing a composite oxide composed of barium, lanthanum and at least one member selected from iron, cobalt, nickel and manganese and, on the first layer, a second layer not containing the composite oxide and containing a metal aluminate supporting at least one noble metal selected from platinum, palladium and rhodium.

Kokai No. 2004-167299 describes a CO decreasing catalyst containing copper, alumina and an oxygen storage material (OSC material) having an ability to prevent alumina from conversion to α form, and this is a CO decreasing catalyst in which the oxygen storage material contains an element for forming a basic oxide, and is specifically, for example, a CO decreasing catalyst obtained by loading copper and an OSC material (Mg or La) on alumina, wherein the copper is preferably in the copper-aluminate form. However, the CO decreasing effect after the catalyst is heat-treated at a temperature more than 600° C. and thereby exposed to a high temperature is unknown.

Furthermore, Kokai No. 2005-185956 describes a catalyst powder containing a noble metal A, a transition metal B such as manganese, iron, cobalt, nickel, copper and zinc, and a porous oxide C, in which the noble metal A and the porous oxide C form a composite D and the noble metal A is present on the composite D, and a method for producing a catalyst, including loading, on a porous oxide C such as alumina, a fine particle formed by mixing a noble metal A and a transition metal B. However, to what extent the catalyst exhibits the purifying activity after being heat-treated at a temperature more than 700° C., and thereby exposed to a high temperature is not known.

### RELATED ART

### Patent Document

Patent Document 1: Kokai No. 2-269669

Patent Document 2: Kokai No. 9-225264

Patent Document 3: Kokai No. 2004-167299

Patent Document 4: Kokai No. 2005-185956

### SUMMARY OF THE INVENTION

### Problems to be Solved by the Invention

Therefore, it has been difficult even with the conventionally known techniques to obtain an exhaust gas purifying catalyst using no platinum-based noble metal as an essential component and capable of substantially maintaining the ability to purify an unreacted substance in an exhaust gas, such as CO, under a low-temperature environment, for example, under a temperature environment of less than 150° C., after exposure to a high temperature of 900° C. or more.

Accordingly, an object of the present invention is to provide an exhaust gas purifying catalyst using no platinum-based noble metal as an essential component and capable of substantially maintaining the ability to purify an unreacted substance in an exhaust gas, such as CO, even under a low-temperature environment after exposure to a high temperature of 900° C. or more.

Another object of the present invention is to provide a production method of the exhaust gas purifying catalyst above.

### Means to Solve the Problems

The present invention relates to an exhaust gas purifying catalyst obtained by loading a solid material composed of M (M is a metal element selected from Cu, Mn, Ni, Fe, Mg and Ag), Co and O on a support having an oxygen absorbing/releasing ability through a thin layer containing Al and O.

The present invention also relates to a method for producing an exhaust gas purifying catalyst, comprising:

a step of preparing a support having an oxygen absorbing/releasing ability,

a step of obtaining a precursor-coated support by coating the surface of the support with a precursor for giving a thin layer containing Al and O,

a step of preparing an acid salt of Co and an acid salt of a metal M (M is a metal element selected from Cu, Mn, Ni, Fe, Mg and Ag), a step of producing a precursor of a solid material composed of M, Co and O from the acid salt of Co and the acid salt of a metal M, and

a step of depositing the solid material precursor on the precursor-coated surface of the precursor-coated support.

### Effects of the Invention

According to the present invention, an exhaust gas purifying catalyst using no platinum-based noble metal as an essential component and capable of substantially maintaining the ability to purify an unreacted substance in an exhaust gas, such as CO, even under a low-temperature environment after exposure to a high temperature of 900° C. or more can be obtained.

In addition, according to the present invention, the exhaust gas purifying catalyst above can be easily obtained.

### BRIEF DESCRIPTION OF THE DRAWINGS

FIG. 1 is a graph depicting by comparison the CO purification characteristics of the exhaust gas purifying catalysts obtained in Examples and Comparative Examples.

FIG. 2 is a conceptual view of the active species of the exhaust gas purifying catalyst according to an embodiment of the present invention.

FIG. 3 is a conceptual view of the active species of the exhaust gas purifying catalyst out of the scope of the present invention.

FIG. 4 is a graph depicting the CO purification characteristics of the active species containing various metals.

FIG. 5 is a copy of an STEM (scanning transmission electron microscope) photograph of the exhaust gas purifying catalyst obtained in Examples.

FIG. 6 is a graph depicting the XRD (X-ray diffraction) measurement results of the exhaust gas purifying catalyst obtained in Examples.

### MODE FOR CARRYING OUT THE INVENTION

Among others, the present invention includes the following embodiments.

1) The exhaust gas purifying catalyst above, wherein the solid material is in a nano-particle form.

2) The exhaust gas purifying catalyst above, wherein the solid material exhibits a spinel crystal structure.

3) The exhaust gas purifying catalyst above, wherein M is Cu.

4) The exhaust gas purifying catalyst above, wherein the support having an oxygen absorbing/releasing ability is composed of a CeO₂ particle, a CeO₂—ZrO₂ composite oxide particle, a CeO₂—TiO₂ composite oxide particle, or a CeO₂—SiO₂ composite oxide particle.

5) The method above, wherein the precursor for giving a thin layer containing Al and O is coated in an amount necessary to form a thin layer having a thickness corresponding to from 1 times to less than 5 times the diameter of one Al atom.

6) The method above, further comprising:

a step of drying and firing the deposited precursor to form a solid material composed of M, Co and O on the thin layer containing Al and O.

7) The method above, wherein the step of obtaining a precursor-coated support is a step of mixing the support having an oxygen absorbing/releasing ability and an Al salt in a solvent, separating a solid mixture form the obtained mixture, and drying the solid mixture.

8) The method above, wherein the step of producing a precursor of a solid material composed of M, Co and O is a step of mixing the acid salt of Co and the acid salt of a metal M in a solvent to obtain a mixed solution.

9) The method above, wherein the step of depositing a precursor of a solid material composed of M, Co and O is a step of mixing the precursor-coated support and a mixed solution containing the precursor of a solid material composed of M, Co and O, separating a solid mixture from the obtained mixture, and drying the solid mixture.

10) The method above, wherein the mixed solution containing a precursor of a solid material composed of M, Co and O is obtained by a method of mixing the acid salt of Co and the acid salt of M in a solvent in the presence of citric acid and ethylene glycol.

In the exhaust gas purifying catalyst of the present invention, a solid material composed of M (M is a metal element selected from Cu, Mn, Ni, Fe, Mg and Ag), Co and O must be supported on a support having an oxygen absorbing/releasing ability through, as an anchor material, a thin layer containing Al and O. Due to this configuration, an exhaust gas purifying catalyst using no noble metal as an essential component and capable of substantially maintaining the ability to purify an unreacted substance in an exhaust gas, such as CO, even under a low temperature environment after exposure to a high temperature of 900° C. or more can be obtained.

The embodiments of the present invention are described in detail below by referring to the drawings.

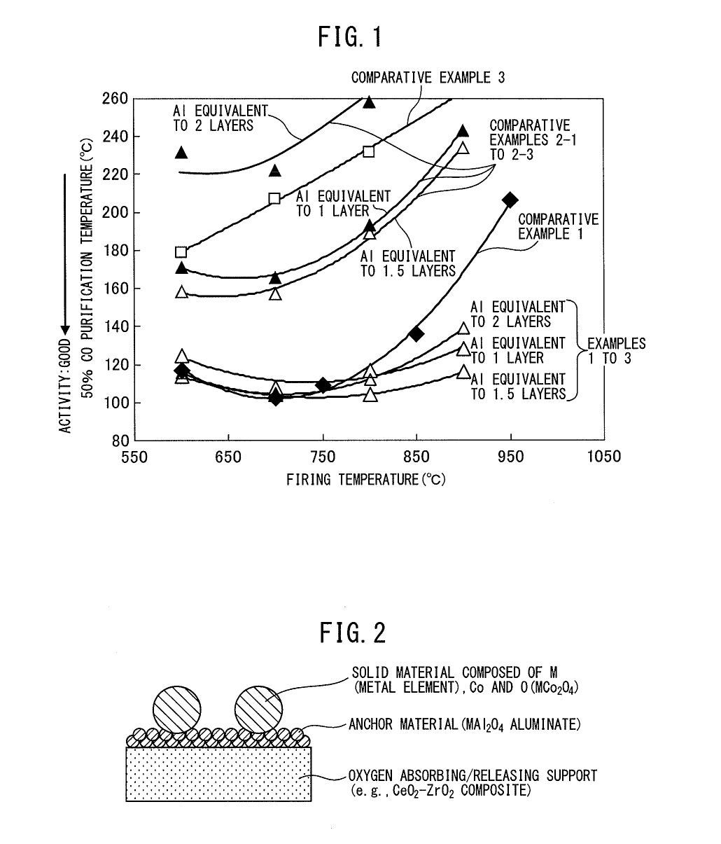

According to the exhaust gas purifying catalyst of an embodiment of the present invention, as shown in FIG. 1, the 50% CO purification temperature after heat treatment at 900° C. is changed by less than 50° C. compared with the 50% CO purification temperature after heat treatment at a temperature of 600 to 800° C., and the purification ability at a low temperature is substantially maintained.

On the other hand, according to an exhaust gas purifying catalyst out of the scope of the present invention, in which a thin layer containing Al and O is not contained as an anchor material, as shown in FIG. 1, the 50% CO purification temperature after exposure to 900° C. becomes higher by 50° C. or more than the 50% CO purification temperature after heat treatment at 600 to 800° C., and the purification ability at a low temperature is not maintained.

Furthermore, according to a gas purifying catalyst that is not within the scope of the present invention, in which a thin layer containing Al and O is not contained as an anchor material and Al is introduced at the time of synthesis of a composite oxide active species, as shown in FIG. 1, the activity of the catalyst is low and the 50% CO purification temperature after heat treatment is high over the range from 600 to 800° C.

In the exhaust gas purifying catalyst of an embodiment of the present invention, as shown in FIG. 2, the solid material composed of M, Co and O and supported on a support having oxygen absorbing/releasing ability through an anchor material, i.e., a thin layer containing Al and O, is usually in a nano-particle form.

Theoretical elucidation of the reason why the exhaust gas purifying catalyst of an embodiment of the present invention can substantially maintain, as described above, good low-temperature purification ability after being heat-treated and thereby exposed to 900° C. is not fully made, but it is considered that, as shown in FIG. 2, an aluminate that is a composite compound made from Al as well as a metal element M and oxygen constituting a composite oxide active species is formed by the heat treatment in the vicinity of the support interface between the support having an oxygen absorbing/releasing ability and a solid material nano-particle serving as a composite oxide active species and works out to an anchor material to suppress sintering of the active species, i.e., the solid material nano-particle of a composite oxide.

The reason why, as shown in FIG. 1, an exhaust gas purifying catalyst that is not within the scope of the present invention, in which the thin layer containing Al and O is not provided, is reduced in the catalytic activity when exposed to a high-temperature environment at 900° C. or more and cannot maintain the purification ability at a low temperature is considered because the active species, i.e., a solid material nano-particle that is a composite oxide, is sintered upon exposure to a high-temperature environment at 900° C. or more.

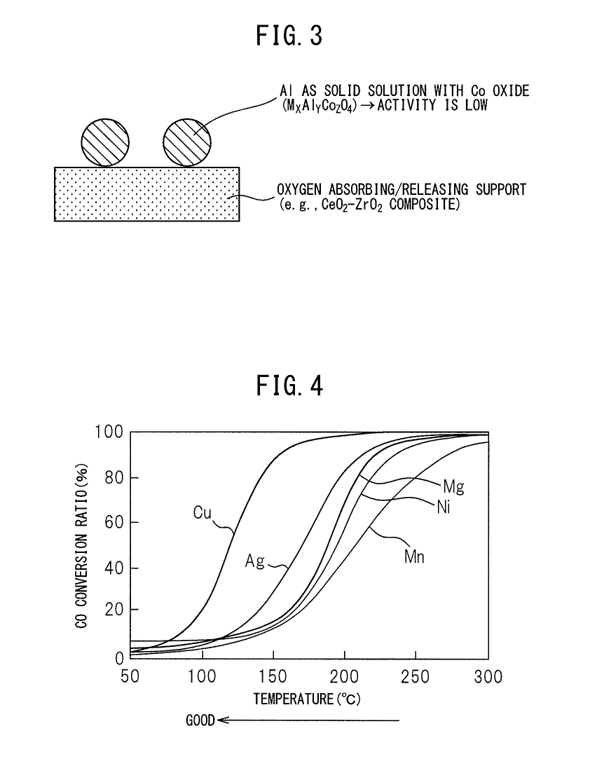

In addition, the reason why, as shown in FIG. 1, heat treatment at a relatively low temperature causes a great reduction in the catalytic activity of an exhaust gas purifying catalyst that is not within the scope of the present invention, which is obtained by introducing Al at the time of synthesis of a composite oxide active species, is considered because, as shown in FIG. 3, Al forms a solid solution in a composite oxide active species of M, Co and O and turns into inactive aluminate.

The catalytic active species in the exhaust gas purifying catalyst of the present invention may be a nano-particle of a solid material composed of M (M is a metal element selected from Cu, Mn, Ni, Fe, Mg and Ag and is preferably Cu), Co and O.

It is understood that when the metal M is Cu, as shown in FIG. 4, the catalytic active species exhibits highest catalytic activity and when the metal M is a metal element selected from Mn, Ni, Fe, Mg and Ag, the active species also exhibits the catalytic activity by the combination with Co.

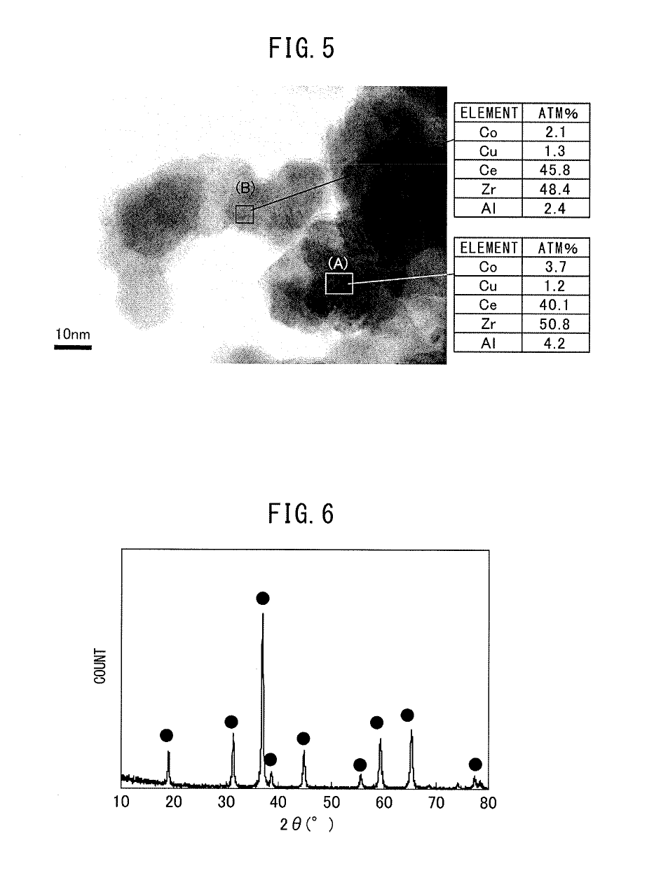

It is also understood that in the exhaust gas purifying catalyst of an embodiment of the present invention, as shown in FIG. 5, a nano-particle as a solid material composed of Cu, Co and O is supported on a CeO₂—ZrO₂ composite support having an oxygen absorbing/releasing ability and, as shown in FIG. 6, the solid material nano-particle has a spinel crystal structure.

In this connection, as shown in FIG. 5, an STEM photograph of the exhaust gas purifying catalyst of an embodiment of the present invention reveals, as the measured elements in the solid material portion, the presence of Ce (about 40 to 46 atm %) and Zr (about 48 to 51 atm %) which are metal elements in the support, Co (about 2 to 4 atm %) and Cu (about 1 atm %) which are metal elements in the solid material that is a catalytic active species, and the presence of Al (about 2 to 4 atm %) which is a metal element in the thin layer intervening between the support and the solid material. This is considered to result because the solid material exists in nm proximity to the support and despite an STEM photograph of the solid material portion, metals in the support are counted.

The spinel crystal structure of the solid material is characterized by the peaks of 2θ=19°, 31°, 37°, 38°, 45°, 56°, 60° and 77° in the XRD measurement results.

In the exhaust gas purifying catalyst of an embodiment of the present invention, the solid material has a spinel crystal structure, whereby the catalyst can have high catalytic activity, among others.

In the present invention, a support having an oxygen absorbing/releasing ability is used, and the above-described solid material composed of M, Co and O is supported on a support having an oxygen absorbing/releasing ability through a thin layer containing Al and O and exists in proximity to the support, so that an unreacted component in the exhaust gas, for example, Co and HC, can be catalytically oxidized by oxygen (molecular or atomic) supplied from the support having an oxygen absorbing/releasing ability and be thereby purified even under a low-temperature environment.

The support having an oxygen absorbing/releasing ability is not particularly limited as long as it is a metal oxide particle having an oxygen absorbing/releasing ability, and examples thereof include a CeO₂ particle, a CeO₂—ZrO₂ composite oxide particle (sometimes simply referred to as CZ), a CeO₂—TiO₂ composite oxide particle, and a CeO₂—SiO₂ composite oxide particle.

The exhaust gas purifying catalyst of the present invention can be obtained, for example, by a method including:

a step of preparing a support having an oxygen absorbing/releasing ability,

a step of obtaining a precursor-coated support by coating the surface of the support with a precursor for giving a thin layer containing Al and O,

a step of preparing an acid salt of Co and an acid salt of a metal M (M is a metal element selected from Cu, Mn, Ni, Fe, Mg and Ag),

a step of producing a precursor of a solid material composed of M, Co and O from the acid salt of Co and the acid salt of a metal M, and

a step of depositing the solid material precursor on the precursor-coated surface of the precursor-coated support.

The precursor-coated support in the production method above can be obtained, for example, through a step of mixing the powder-form support having an oxygen absorbing/releasing ability and an Al salt in a solvent, for example, in water, separating a solid mixture form the obtained mixture, and drying the solid mixture.

Alternatively, the precursor-coated support can also be obtained by a method of coating a slurry of the powder-form support having an oxygen absorbing/releasing ability on a base material, for example, a base material such as heat-resistant porous ceramic-made honeycomb, then drying, if desired, the coating, applying a solvent solution containing an Al salt, for example, an aqueous solution, and drying the coating.

It is believed that by virtue of providing the above-described thin layer containing Al and O on the support surface, an aluminate layer made from Co, Al and O in the solid material composed of M, Co and O supported on the thin layer is formed by heat treatment and works out to an anchor material and, as a result, sintering of the active species, i.e., a solid material nano-particle composed of M, Co and O, can be suppressed.

In the method above, the precursor in the coated support is preferably coated in an amount necessary to form a thin layer having a thickness corresponding to from 1 times to preferably less than 5 times, more preferably from 1 to 3 times, still more preferably from 1 to 2 times, the diameter of one Al atom.

If the precursor is coated in an amount necessary to form a thin layer having a thickness corresponding to less than 1 times or 5 times or more the diameter of one Al atom, the activity of the obtained exhaust gas purifying catalyst is disadvantageously decreased.

The thickness of the thin layer containing Al and O can be calculated, for example, by the following method:

1) a step of estimating the primary particle diameter from the STEM observation results of the support (for example, CZ),
2) a step of calculating the surface area of the primary support particle,
3) a step of calculating the volume of the primary support particle,
4) a step of calculating the total volume of the support from the amount of the support used and the density of the support and dividing the total volume by the volume of the primary support particle to calculate the number of support particles,
5) a step of calculating the projected area of the Al ion from the Al ion radius,
6) a step of calculating the number of Al ions loaded on the primary support particle from 2) to 5) above,
7) a step of calculating the number of Al ions loaded on all support particles from 3) to 6) above,

8) a step of calculating the molar number of Al at the time of loading of 1 layer on the support particle from 7) above, and
9) a step of calculating the amount of an Al salt added from the molecular weight of the Al salt.

Through these steps, the amount of the precursor coated such that the thin layer containing Al and O has, as an optimal thickness, a thickness corresponding to approximately from 1 times to less than 5 times the diameter of one Al atom, can be calculated.

In the method for producing an exhaust gas purifying catalyst of an embodiment of the present invention,

the acid salt of Co and the acid salt of a metal M (M is a metal element selected from Cu, Mn, Ni, Fe, Mg and Ag) are prepared in a molar ratio of Co salt and M salt (Co salt:M salt) of 2:X [(X is 1 (when M is Cu, Mn, Ni, Fe or Mg) or 2 (when M is Ag)],

the precursor of a solid material composed of M, Co and O is produced from the acid salt of Co and the acid salt of a metal M,

the solid material precursor is deposited on the precursor-coated surface of the precursor-coated support, and

the deposited precursor is usually further dried and fired to form a solid material composed of M, Co and O on the thin layer containing Al and O.

In the production method, the method for producing the precursor of a solid material composed of M, Co and O includes a method of obtaining, for example, a mixed solution containing the precursor of a solid material composed of M, Co and O, a method of mixing, for example, the acid salt of Co and the acid salt of a metal M to obtain a mixed solution, in particular, a method of mixing the acid salt of Co and the acid salt of M in a solvent in the presence of citric acid and ethylene glycol, a coprecipitation method, a sol-gel method, an impregnation method, etc., and is preferably a method of mixing the acid salt of Co and the acid salt of M in a solvent in the presence of citric acid and ethylene glycol.

In the mixed solution obtained by mixing the acid salt of Co and the acid salt of a metal M in a solvent, the acid salt of Co and the acid salt of a metal M are preferably contained to account for a ratio of 0.01 to 0.2 mole/L in total.

In addition, in the method above, the amounts of citric acid and ethylene glycol are preferably from 1 to 10 times equivalent of citric acid and from 1 to 10 times equivalent of ethylene glycol, relative to the metal cation.

In the method above, the method for depositing the precursor of a solid material composed of M, Co and O includes a method of mixing the precursor-coated support and a mixed solution containing the precursor of a solid material composed of M, Co and O, and separating a solid mixture from the obtained mixture.

In addition, the method for depositing the precursor of a solid material composed of M, Co and O includes a method where a mixed solution, for example, an aqueous solution, containing the precursor of a solid material composed of M, Co and O is applied onto an Al salt-containing thin layer coated and dried on a powder-form support having an oxygen absorbing/releasing ability and being coated on a base material such as heat-resistant porous ceramic-made honeycomb and the coating is dried.

The acid salt of Co includes a nitrate, a sulfate, an acetate, etc. of Co.

The acid salt of a metal M includes a nitrate, a sulfate, an acetate, etc. of a metal selected from Cu, Mn, Ni, Fe, Mg and Ag.

The amount of the acid salt of Co and the amount of the acid salt of a metal M may be such an amount that the amount of Co supported becomes from 1 to 10 mass %, for example, from 2 to 5 mass %.

In the method for producing an exhaust gas purifying catalyst of an embodiment of the present invention, the solvent of the mixed solution includes an alcohol such as methanol, ethanol and isopropanol, and water, and is preferably water.

In an embodiment of the present invention, after carrying out the method above, the deposited precursor is further dried and fired to form a solid material composed of M, Co and O on the thin layer containing Al and O and thereby obtain an exhaust gas purifying catalyst.

The drying and firing above may be performed in air by drying at 50 to 200° C. and firing at a temperature of 400° C. to less than 800° C., preferably at a temperature of 400 to 600° C., for 1 to 10 hours, for example, from 2 to 8 hours.

By the above-described method, the exhaust gas purifying catalyst of an embodiment of the present invention, in which a nano-particle of a solid material composed of M, Co and O is supported on a support having an oxygen absorbing/releasing ability through a thin layer containing Al and O, can be obtained.

The exhaust gas purifying catalyst of the present invention can be used for purifying an exhaust gas from an internal combustion engine, for example, an automobile engine.

In the case of removing CO and HC by using the exhaust gas purifying catalyst of the present invention, the catalyst may be used by providing at least two regions varying in the temperature. For example, the temperature in the region for the purification of CO may be set to be lower than the temperature in the region for the purification of HC.

In addition, the exhaust gas purifying catalyst of an embodiment of the present invention can be used as a catalytic device usually by coating it on a base material such as honeycomb.

The honeycomb usable as the base material can be formed of a ceramic material such as cordierite, a stainless Steel, etc. Furthermore, the exhaust gas purifying catalyst of the present invention can be used by molding it into various shapes.

### EXAMPLES

Examples of the present invention are described below.

The following Examples have a merely explanatory purpose and are not intended to limit the present invention.

The measuring methods in each of the following Examples are an illustrative example, and an arbitrary method considered equivalent by one skilled in the art can be employed.

In each of the following Examples, the dispersed state of the supported catalyst was observed by performing STEM (Scanning Transmission Electron Microscopy) measurement so as to confirm that the solid material particle of the obtained exhaust gas purifying catalyst is a nano-particle and to determine the average particle diameter (average primary particle diameter) of nano-particles, and whether the solid material has a spinel crystal structure was confirmed from the peak position by performing XRD (X-Ray Diffraction) measurement.

In addition, the presence of a composite solid material composed of M, Co and O in the catalyst was confirmed by performing STEM-EDX analysis (Scanning Transmission Electron Microscopy-Energy Dispersive X-ray Spectroscopy).

Furthermore, with respect to the exhaust gas purifying catalyst, the CO purification performance was evaluated by the CO oxidation activity under the following conditions.

### Conditions in Evaluation of Purification Ability of Catalyst:

Amount of catalyst used: about 0.75 g
Gas flow rate: 1 L/min
SV (Space Velocity): about 90,000 h⁻¹
Gas: CO: 0.65%, C₃H₆: 0.05%, O₂: 0.58%, N₂: balance A/F=15.02

The CO oxidation activity was evaluated by raising the temperature to 600° C. under the conditions above.

### Example 1

### 1. Preparation of a Support in which the Surface is Coated with a Precursor for Giving a Thin Layer containing Al and O

(1) A CeO₂—ZrO₂ composite (ACTALYSLISA, CeO₂—ZrO₂ solid solution, CATALER Corporation; hereinafter simply referred to as CZ) was prepared and measured for the specific surface area by BET method, and the certainty of the following calculation was confirmed by comparing the measured value with the value of the specific surface area determined from A×B/amount of support (g).

(2) The amount of aluminum nitrate necessary for uniformly coating the support surface was calculated by the following procedure, and a required molar amount of Al salt necessary for the loading of 1 layer on all support CZ particles was collected, dissolved in 200 mL of distilled water and dried.

1) The primary particle diameter was estimated to be 20 nm from the STEM observation results of the support (CZ).

2) The surface area of the primary support particle was calculated as 1.26×10⁻¹⁵ m² (A).

3) The volume of the primary support particle was calculated as 4.19×10⁻²⁴ m³.

4) The total volume of the support was calculated as 1.32×10⁻⁶ m³ from the amount (9.5 g) of the support used (measured specific surface area: 43.45 m²/g) and the density (7.215 g/cm³) of the support, and the number of support CZ particles was calculated as 3.14×10¹⁷ (B) by dividing the total volume by the volume of the primary support particle.

5) The projected area of the Al ion was calculated as 1.04×10⁻¹⁹ m² from the Al ion radius (1.61×10⁻¹⁰ m).

6) The number of Al ions loaded on the primary support CZ particle was calculated as 12,119 from 2) to 5) above.

7) The number of Al ions loaded on all support CZ particles was calculated as 3.81×10²¹ from 3) to 6) above.

8) The molar number of Al at the time of loading of 1 layer on all support CZ particles was calculated as 6.33×10⁻³ mol from 7) above.

9) The amount of Al salt added was calculated as 2.374 g from the molecular weight (375.13) of Al(NO₃)₃.9H₂O that is an Al salt.

(3) The support powder was added to the solution of 2) above, stirred, mixed and then dried at 1,200° C.

### 2. Synthesis of an Active Species Precursor of a Solid Material Composed of a Composite Oxide

1) Cobalt nitrate weighed such that the amount of Co metal supported becomes 5 wt %, and copper acetate in an amount of 1/2 by mol of Co salt were dissolved in pure water, thoroughly stirred and mixed to prepare a solution.

2) A mixed solution consisting of citric acid in an amount of 3 times equivalent to the total amount of metal cations, ethylene glycol in an amount of 3 times equivalent to the total amount of metal cations, and water was thoroughly stirred and mixed to prepare a solution.

### 3. Production of an Exhaust Gas Purifying Catalyst

After thoroughly mixing the solutions of 1) and 2) of 2. above, the precursor-coated CZ support of 1. above in which the surface is coated with a precursor for giving a thin layer containing Al and O, was added to make the supported amount 5 wt % in terms of Co metal, thoroughly stirred at room temperature, and heated/dried at 70° C. for 2 hours and then at 140° C. for 4 hours, under reduced pressure in an evaporator by using a refluxing device, to obtain a gel-like precursor solid product.

The obtained solid product was fired in a stepwise manner up to 400° C. over 9 hours in an electric furnace to obtain an exhaust gas purifying catalyst.

### 4. Evaluation of an Exhaust Gas Purifying Catalyst after Heat Treatment

The obtained exhaust gas purifying catalyst was heat-treated in air in a firing furnace at 600° C., 700° C., 800° C. or 900° C. for 33 hours and then evaluated for the purification ability under the above-described conditions.

The results obtained are shown together with other results in FIG. 1.

### Example 2

An exhaust gas purifying catalyst was obtained in the same manner as in Example 1 except that in the step (2) above, the amount of aluminum nitrate necessary for uniformly coating the support surface was calculated by the same procedure as above and a required molar amount of Al salt necessary for the loading of 1.5 layers on all support CZ particles was collected, dissolved in 200 mL of distilled water, dried and fired.

The results obtained using this exhaust gas purifying catalyst are shown together with other results in FIG. 1.

### Example 3

An exhaust gas purifying catalyst was obtained in the same manner as in Example 1 except that in the step (2) above, the amount of aluminum nitrate necessary for uniformly coating the support surface was calculated by the same procedure as above and a required molar amount of Al salt necessary for the loading of 2 layers on all support CZ particles was collected, dissolved in 200 mL of distilled water, dried and fired.

The results obtained using this exhaust gas purifying catalyst are shown together with other results in FIG. 1.

### Comparative Example 1

An exhaust gas purifying catalyst was obtained in the same manner as in Example 1 except that an untreated CZ support was used in place of the precursor-coated CZ support.

The results obtained using this exhaust gas purifying catalyst are shown together with other results in FIG. 1.

### Comparative Examples 2-1 to 2-3

Exhaust gas purifying catalysts were obtained in the same manner as in Example 1, Example 2 or Example 3 except that when synthesizing the precursor of a composite oxide active species, an Al salt in the same amount as the amount of Al salt added in Example 1 was added to synthesize a precursor of an Al salt-containing composite oxide active species and mixed with an untreated CZ support in place of the precursor-coated CZ support.

The results obtained using these exhaust gas purifying catalysts are shown together with other results in FIG. 1.

### Comparative Example 3

A precursor was synthesized by adding NaOH as a neutralizer to the same amount of aluminum nitrate as the amount of aluminum salt added in Example 1 and then fired at 600° C. for 4 hours to obtain an Al₂O₃ powder.

The obtained Al₂O₃ powder and the support CZ powder were physically mixed in an agate mortar to obtain a physically mixed composite support.

The physically mixed composite support obtained was impregnated and loaded with the composite oxide active species precursor described in Example 1 and thereafter, dried and fired in the same manner as in Example 1 to obtain an exhaust gas purifying catalyst.

The results obtained using this exhaust gas purifying catalyst are shown together with other results in FIG. 1.

### Reference Example 1

Cobalt nitrate weighed such that the amount of Co supported becomes wt %, and copper nitrate weighed such that the amount of Cu atom supported becomes 2 wt %, were dissolved in pure water and thoroughly stirred.

A mixed aqueous solution consisting of 1 mol/L NaOH (Aldrich) and pure water was thoroughly stirred/mixed and thereby dissolved.

An aqueous solution of 1, 2 above was introduced at a liquid feed rate of 2.5 mL/min into a reaction vessel (SA reactor) with a stirring device capable of imposing, onto the mixed aqueous solution, a shear stress resulting from super agitation by a stirrer rotating at a rotation speed of 8,000 to 12,000 rpm, and a neutralization reaction was performed at 0 to 50° C. for about 1 hour to precipitate a precursor of a Cu—Co—O solid solution.

Pure water was introduced into the obtained precursor, and the resulting mixture was centrifuged, filtered and washed.

CZ was introduced into the obtained precursor slurry, and the resulting mixture was evaporated to dryness, cracked, and fired under the atmosphere at 600° C. for 4 hours to obtain a CO oxidation catalyst.

The CO purification performance was measured under the above-described evaluation conditions, and the results obtained are shown together with other results in FIG. 4.

### Reference Examples 2 to 5

Catalysts (M-Co—O (M: a metal except for Co)) were obtained in the same manner as in Reference Example 1 except that a nitrate of Mg, Mn, Fe, Ni or Ag was used in place of copper nitrate.

The results of evaluation using the obtained catalysts are shown in FIG. 4.

### INDUSTRIAL APPLICABILITY

According to the present invention, an exhaust gas purifying catalyst using no platinum-based noble metal and capable of substantially maintaining the ability to purify an unreacted substance such as carbon monoxide (CO) even under a low ambient temperature after exposure to a high temperature can be obtained.

1. An exhaust gas purifying catalyst obtained by loading a solid material composed of M (M is a metal element selected from Cu, Mn, Ni, Fe, Mg and Ag), Co and O on a support having an oxygen absorbing/releasing ability through a thin layer containing Al and O and having a thickness corresponding to from 1 to 2 times the diameter of one Al atom.

2. The exhaust gas purifying catalyst according to claim 1, wherein said solid material is in a nano-particle form.

3. The exhaust gas purifying catalyst according to claim 1, wherein said solid material exhibits a spinel crystal structure.

4. The exhaust gas purifying catalyst according to claim 1, wherein said M is Cu.

5. The exhaust gas purifying catalyst according to claim 1, wherein said support having an oxygen absorbing/releasing ability is composed of a CeO₂ particle, a CeO₂—ZrO₂ composite oxide particle, a CeO₂—Al₂O₃ composite oxide particle, a CeO₂—TiO₂ composite oxide particle, a CeO₂—SiO₂ composite oxide particle, or a CeO₂—ZrO₂—Al₂O₃ composite oxide particle.

6. A method for producing an exhaust gas purifying catalyst, comprising:
a step of preparing a support having an oxygen absorbing/releasing ability,
a step of obtaining a precursor-coated support by coating the surface of said support with a precursor for giving a thin layer containing Al and O and having a thickness corresponding to from 1 to 2 times the diameter of one Al atom,
a step of preparing an acid salt of Co and an acid salt of a metal M (M is a metal element selected from Cu, Mn, Ni, Fe, Mg and Ag),
a step of producing a precursor of a solid material composed of M, Co and O from said acid salt of Co and said acid salt of a metal M, and
a step of depositing said solid material precursor on the precursor-coated surface of said precursor-coated support.

7. The method according to claim 6, wherein said precursor for giving a thin layer containing Al and O is coated in an amount necessary to form a thin layer having a thickness corresponding to from 1 times to less than 5 times the diameter of one Al atom.

8. The method according to claim 6, further comprising:
a step of drying and firing the deposited precursor to form a solid material composed of M, Co and O on said thin layer containing Al and O.

9. The method according to claim 6, wherein said step of obtaining a precursor-coated support is a step of mixing said support having an oxygen absorbing/releasing ability and an Al salt in a solvent, separating a solid mixture form the obtained mixture, and drying the solid mixture.

10. The method according to claim 6, wherein said step of producing a precursor of a solid material composed of M, Co and O is a step of mixing said acid salt of Co and said acid salt of a metal M in a solvent to obtain a mixed solution.

11. The method according to claim 6, wherein said step of depositing a precursor of a solid material composed of M, Co and O is a step of mixing said precursor-coated support and a mixed solution containing said precursor of a solid material composed of M, Co and O, separating a solid mixture from the obtained mixture, and drying the solid mixture.

12. The method according to claim 10, wherein said mixed solution containing a precursor of a solid material composed of M, Co and O is obtained by a method of mixing the acid salt of Co and the acid salt of M in a solvent in the presence of citric acid and ethylene glycol.
